(19) United States
(12) Patent Application Publication
(10) Pub. No.: US 2009/0157475 A1
(43) Pub. Date: Jun. 18, 2009

(54) METHOD AND SYSTEM FOR ELECTRONIC INCENTIVE DISTRIBUTION AND TASK MANAGEMENT

(76) Inventors: Jordan Chase Crafton, Hanover, IN (US); David Michael Shepard, Noblesville, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 11/958,971

(22) Filed: Dec. 18, 2007

(51) Int. Cl. G06Q 30/00

(52) U.S. Cl. 705/10; 705/14

(57) ABSTRACT

A method of manufacturer incentive distribution to consumers is provided the method comprises receiving a first list from a consumer, the first list having at least one item the consumer wishes to purchase, receiving an incentive from at least one incentive provider, the incentive being associated with a keyword on a second list of keywords, comparing the keyword in the second list to the at least one item in the first list, creating a third list which includes the incentive associated with the keyword if the keyword matches the at least one item in the first list, transmitting the third list to the consumer to permit the consumer to choose the incentive, receiving the consumer's choice of the incentive; and transmitting to the consumer the incentive.

### FIELD OF THE INVENTION

The present invention relates generally to online list management and more particularly to online management and distribution of merchant incentives.

### BACKGROUND

Generally, consumers who wish to improve their buying power use merchant incentives, such as coupons. The usual way to obtain coupons is to search local newspapers or coupon packets received in the mail. Alternatively, consumers may visit internet sites that offer coupons for certain merchants. These may or may not be product specific. In any of the above ways, the consumer is forced to search for coupons, cut out the coupons from the newspaper or the mailing packets, or print the coupons from the internet site. Further, the consumer is forced to manage these physical coupons either loosely or organize the coupons into categories, e.g., grocery, electronics, etc. Additionally, most if not all coupons have expiration dates. Therefore, as part of the coupon organization process, the consumer has to also discard the coupons that have already expired. Certain coupons are not product-based but are issued from the point of sale. Managing these coupons poses an additional level of difficulty in that the consumer has to not only organize coupons based on product categories, but also based on the point of sale. Maximizing savings by optimizing point of sale coupons vs. product-category coupons can become a daunting task.

Consumers can use various electronic devices to manage lists and to transfer those lists to others. For example, a wish-list of items to be purchased can be generated on a personal digital assistant (PDA) for an upcoming holiday or birthday. Currently, a PDA capable of wireless communication can send the wish-list to another PDA, also capable of wireless communication. However, many consumers do not possess an electronic device and those that do may not have a device with wireless communication capabilities. Also, there are no easy ways to control versions of the wish-list.

Therefore, there is a need for a system to manage and distribute incentives, as well as manage consumer lists.

### SUMMARY OF THE INVENTION

The present teachings provide methods for distributing incentives from incentive providers to consumers and manage consumer lists.

In one form thereof, a method of distributing incentives from incentive providers to consumers is provided. This method comprises receiving a first list from a consumer containing an item to purchase, receiving an incentive from at least one incentive provider in a second list containing a keyword associated with the incentive, comparing the items of the first list to the keyword in the second list, creating a third list containing the incentive associated with the keyword if the keyword matches the item in the first list, transmitting the third list to the consumer to permit the consumer to choose the incentive, receiving the consumer's choice of the incentive, and transmitting to the consumer the incentives.

In another form thereof, a method of distributing incentives from incentive providers to consumers is provided. This method comprises receiving an incentive from at least one incentive provider, transmitting to the at least one incentive provider a first list containing information associated with consumers, receiving bids from the at least one incentive provider on the information associated with consumers in the first list (each bid associated with the incentive) communicating with a user, comparing information of the user with the information associated with consumers in the first list, creating a second list which includes the incentive associated with the at least one incentive provider that placed bids on the information associated with consumer in the first list if the information of the user matches the information associated with consumers, transmitting to the user the second list to permit the user to choose the incentive, receiving the user's choice of the incentive, transmitting to the user the incentive, and charging the at least one incentive provide the bid amount associated with the incentive.

### BRIEF DESCRIPTION OF DRAWINGS

The above-mentioned and other advantages of the present invention and the manner of obtaining them, will become more apparent and the invention itself will be better understood by reference to the following description of the embodiments of the invention taken in conjunction with the accompanying drawings, wherein:

FIG. 1 is a schematic view of connectivity between users of electronic incentive distribution and task management system according to the current teachings;

FIG. 2 is a schematic of data transfer between users of the electronic incentive distribution and task management system according to the current teachings;

FIG. 3 is a schematic of user connectivity with the electronic incentive distribution and task management system;

FIG. 4 is a schematic of consumers accessing the electronic incentive distribution and task management system;

FIG. 5 is a schematic of consumer list entry according to the current teachings;

FIG. 6 is a schematic of merchants accessing the electronic incentive distribution and task management system;

FIG. 7 is a schematic of the process of registering electronic coupons by the merchant;

FIG. 8 is a schematic of the process of registering incentives by a point of sale vendor;

FIG. 9 is an exemplary schematic of a process of a merchant bidding on keywords;

FIG. 10a is an exemplary schematic view of a process of matching a consumer's keyword entry;

FIG. 10b is an exemplary exploded view of coupons presented to the consumer;

FIG. 10c is an exemplary schematic view of a process of a Point of sale vendor bidding on consumer information;

FIG. 11 is an exemplary schematic view of a coupon history report provided to merchants;

FIG. 12 is a schematic view of the electronic incentive distribution and task management system's suggestion wizard for purchase lists; and

FIG. 13 is a schematic view of the electronic incentive distribution and task management system's reminder wizard according to the current teachings.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Hereinafter, the terms client, consumer, user, and customer are used interchangeably for those who receive incentives and services from the electronic incentive distribution and task management system (hereinafter “System”). Also, the term merchant is used to mean a point of sale (POS) vendor or manufacturer as those who provide incentives to the System.

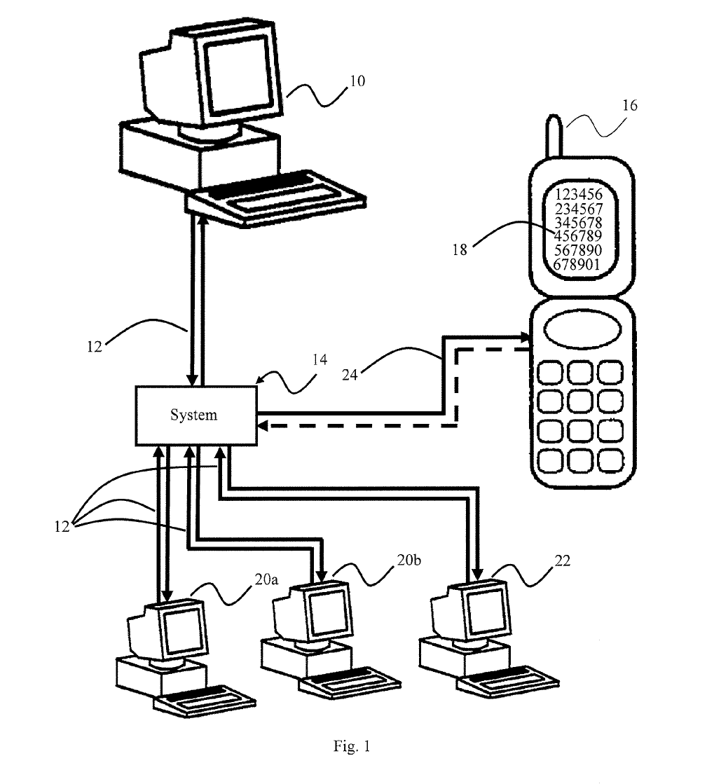

Referring to FIG. 1, connectivity between a consumer, a point of sale vendor, manufacturer, other list user, and the System is shown. The consumer enters data via consumer data entry terminal 10. The data is communicated to System 14 by network 12. Client output device 16 receives client output data 18 from System 14 over communication link 24. The communication link 24 is shown as a two-way link, however, it is possible that the client output device 16 only receives information from System 14 and does not transmit (hence, the connection between the client output device 16 and System 14 is shown in phantom). Point of sale vendor data entry terminal 20a and manufacturer data entry terminal 20b also communicate with System 14 over network 12. Other data entry terminals 22 for list users may be connected to System 14 via network 12. More detail related to all of the entities communicating with System 14, including other list user data entry terminal 22, is forthcoming.

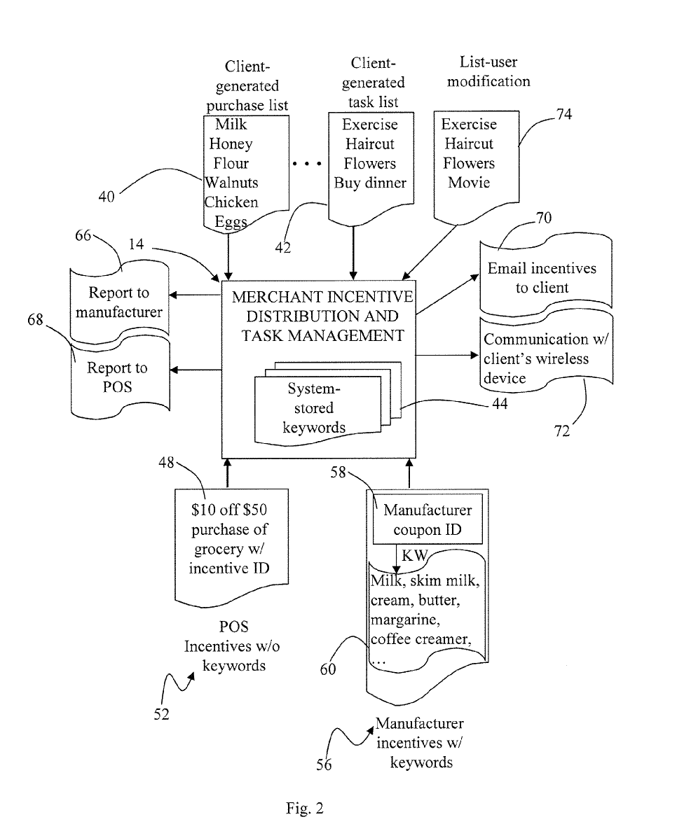

Referring now to FIG. 2, a general overview of data transfer between different entities and System 14 is shown. Client may generate a purchase list 40 including such items as milk, honey, flour, walnuts, chicken, and eggs from data entry terminal 10. This list is recognized by System 14 as a series of keywords. The list can be entered one keyword at a time or the entire list can be submitted to System 14 all at once. The client can also provide a task list 42, comprising a series of items.

System 14 is tasked with matching client generated list with incentives that are imported from manufacturers or POS vendors. This is done by either matching keywords that are stored 44 by System 14, and/or by matching keywords 60 provided by the manufacturer. Therefore, a manufacturer provides incentives in the form of coupons, as designated by arrow 56. The manufacturer, e.g., a dairy product manufacturer, desires to provide incentives 58 for shoppers to purchase more of the manufacturer's products as compared to the competitors'. The manufacturer may provide keywords associated with the incentives as shown by reference numeral 60. In the above example, the manufacturer provides coupon IDs for a variety of dairy products. The terms coupon ID and coupon code are used interchangeably and are to be given the same meaning. The manufacturer also provides certain keywords to match incentives with keywords provided by the consumer. These keywords may be milk, skim milk, cream, butter, margarine, coffee creamer, etc. System 14 uses these keywords and the system-stored keywords 44 to match the incentive 58 to the client generated purchase list 40. The system-stored keywords 44 are organized based on categories. For example under the category of “dairy” System 14 may have stored some of the above terms in addition to “soy milk.” The system-stored keywords 44 are updated occasionally to encompass new terms. On the other hand, only the manufacturer-provided keywords 60 may be used at the request of the manufacturer and the system-stored keywords 44 ignored. Furthermore, the manufacturer can solely rely on the system-stored keywords 44.

Alternatively, a POS vendor may provide incentive, e.g., in the form of certain amount of discount for certain amount of purchase. This is shown in FIG. 2, designated by arrow 52. The POS vendor provides the incentive 48 with an incentive code. The terms incentive code and incentive ID are used interchangeably and are to be given the same meaning. The POS vendor is, for example, a chain of grocery stores with multiple locations. Each of the POS vendors has a location identification number that can be compared and matched to the location of the consumer.

System 14 also provides reports to manufacturers and POS vendors, as designated by reference numerals 66 and 68, respectively. The report to manufacturer may contain usage of issued coupon IDs broken down to weekly, monthly, and yearly, trends of coupon usage, etc. Reports to POS vendors may include information about consumers, their locations, and their buying habits, usage of the issued incentive IDs based on weekly, monthly, and yearly usage.

System 14 can also transmit the incentives to the consumer's computing device as shown by the reference numeral 70. Alternatively, the user can receive the coupon IDs, or incentive IDs on her wireless communication device to present to the cashier at the time of purchase, as represented by reference numeral 72. The approach of wirelessly communicating incentive and coupon IDs is extremely beneficial to the user since this approach completely eliminates the need for managing physical coupons. Thus, the consumer no longer has to print, cut out, collate, organize, and carry the coupon to the POS vendor.

Another feature of System 14 is to manage tasks for the client. A list can be entered by the client comprising task items 42 so that System 14 can remind the client to perform these tasks. The items on the list can be required to be accomplished by a certain time of a day or by the end of a day. These items 42 are communicated to System 14 and time stamped and will be used to remind the client, as will be discussed in more detail below. System 14 uses emails and wireless communication with the client, similar to the way coupon and incentive codes were communicated to the client, to remind the client of the deadlines for the tasks. Additionally, other list users can modify the task list of the client. For example, the client's spouse can logon to System 14, view the task list and modify the task list by adding or removing items. This list-user modification capability is shown in FIG. 2 as reference numerals 42 and 74. The item “Movie” was added to the client list 42 by the list user to remind the client that she should also get a movie; however, the item “Buy dinner” was removed from the client list signifying that this item no longer needs to be accomplished by the client. The client can assign modification rights to the list containing task items. These rights include no modification by anyone other than the client, addition rights only, and full modification rights including additions and deletions.

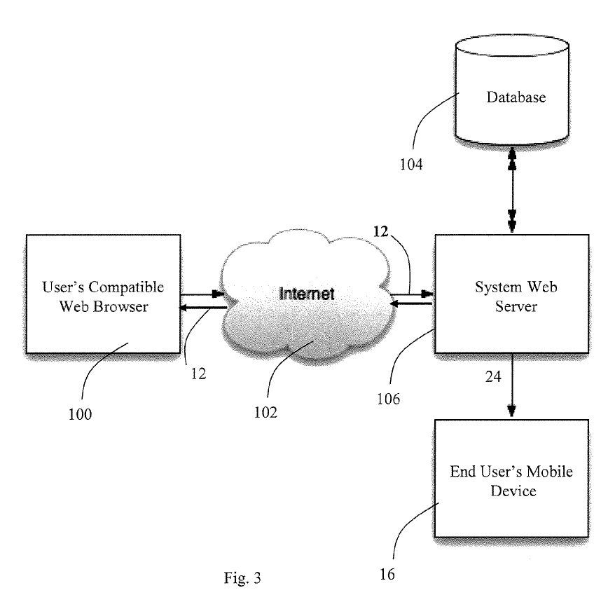

Now referring to FIG. 3, connectivity between the user or client and System 14 is shown in closer detail. The user's compatible web browser 100 connects to System 14 web server 106 over the internet 102 using network channels 12. This is accomplished by the user entering the web address of System 14 into the address portion of the web browser. In the normal course of operations, resident software of System 14 (hereinafter “the Software”) located on the web server 106 transfers information the user has entered to database 104. System 14 uses wireless channel 24 to communicate with the end user's mobile device 16 or uses network channels 12 to communicate with the user's computing device to transfer information back to the user. At this point, it should also be noted that System 14 can utilize land line in place of wireless channel 24 as shown in FIGS. 1 and 3. The use of wireless channels allows the user to gain access to incentive and coupon codes as well as task reminders while holding a mobile device. Additionally, the stated use of landlines or wireless channels can be extended to access a kiosk or a moveable wireless device mounted on a, e.g., a shopping cart, to download and process the incentive and coupon codes.

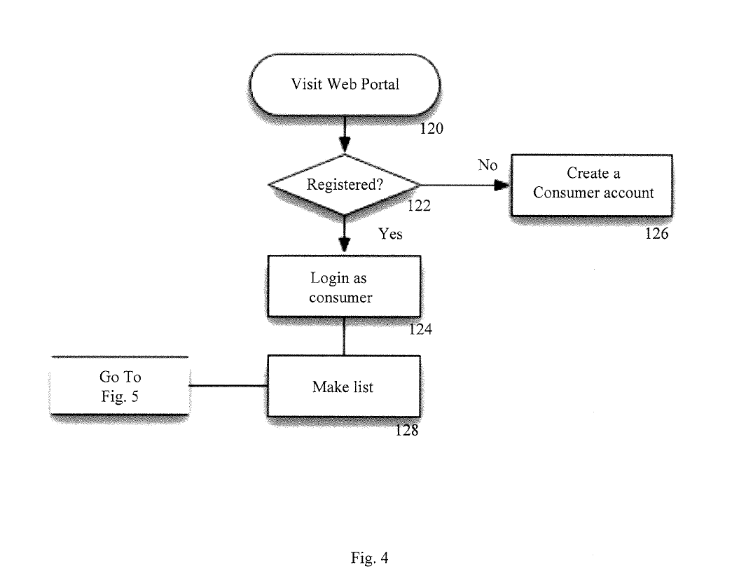

Now referring to FIG. 4, a flow chart is presented to show the user accessing System 14 through terminal 10. The user enters System 14 through the web portal 120 by entering the website address associated with System 14, which was already described in FIG. 3. Immediately upon entering System 14, the Software asks the user whether she is already registered, as designated by the decision box 122. If the user answers “No” to this question, the Software invites the user to create an account, as designated by reference numeral 126. Creation of an account requires the user to enter certain information, e.g., address. If the answer is “Yes” then the user logs in as consumer (block 124) by entering user ID and password. Logging in as a consumer is to be distinguished from logging in as a merchant as will be seen, below. Once the consumer has logged in, she can begin making her list (block 128) via a client data entry terminal 10.

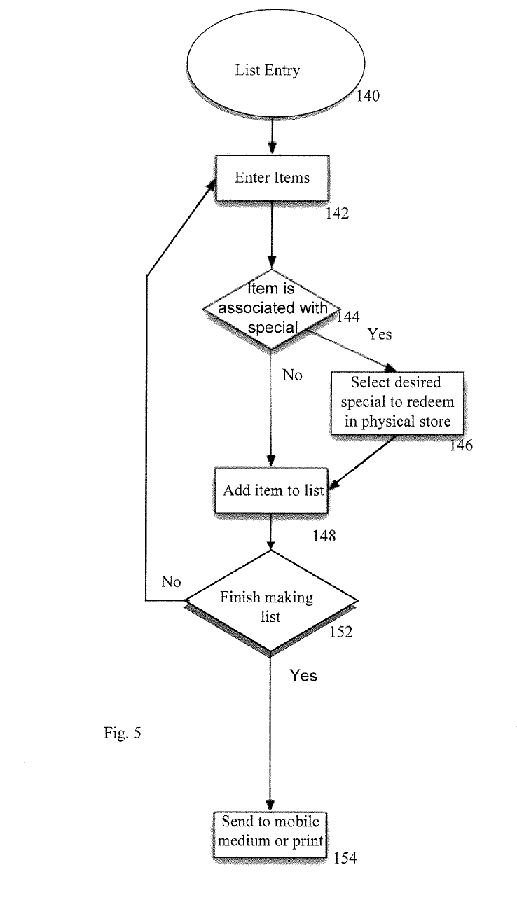

The process of making a list is shown in FIG. 5. The Software guides the user to list making entry block 140. She enters items at the client data entry terminal 10 which corresponds to block 142. For each item the Software of System 14 examines whether the item is associated with an incentive, as shown with the decision box 144. The matching is accomplished based on the item and the associated keywords as entered by the merchants and the system-stored keywords 44 as discussed above. The Software compares the item with a list of keywords, generated from a combination of merchant entered keywords 60 and system-stored keywords 44. Once a keyword (and thereby the incentive associated with that keyword) is matched with the item, the Software presents the incentive to the user in block 146. At this point several incentives may be available and presented. The user is asked to select one or more of the incentives. Depending on which incentives she selects, or no incentive at all, the item will be added to the list in block 148 and the Software attaches the incentives to the item. If the item cannot be matched with an incentive, the Software adds the item to the list without attaching an incentive. After each item, the Software presents a question to the user as shown in decision box 152. The process will continue until the user answers “Yes” to the question asked by the Software (decision box 152) asking if the user is finished making the list. Once the list is completed, the Software sends the list of incentives represented by incentive IDs to the mobile device and/or to the user's computing device as shown in block 154. Alternatively, the user may choose to save the incentives in the System 14 for dispensation at a future time. The System 14 can then remind the user of upcoming expiration dates of the coupons as will be explained later.

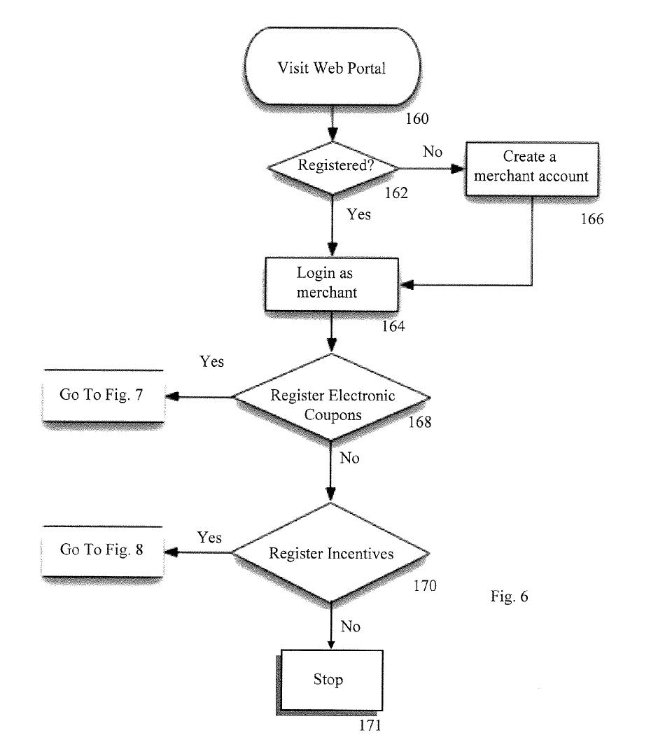

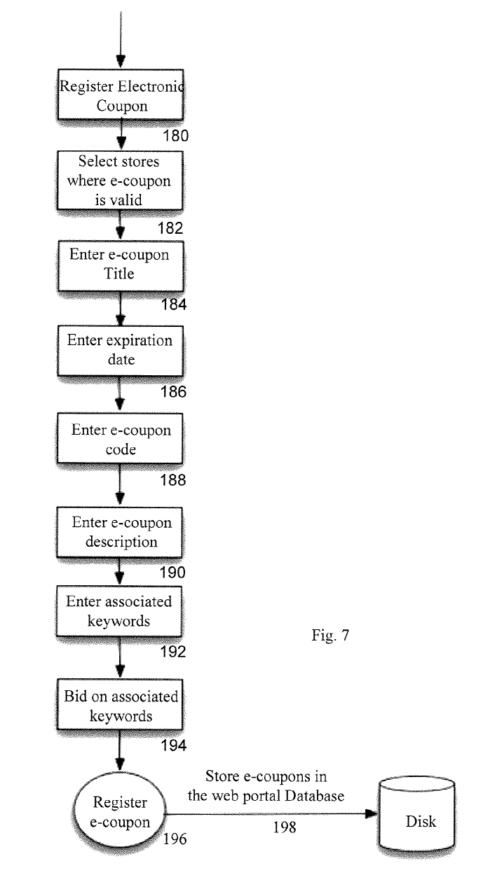

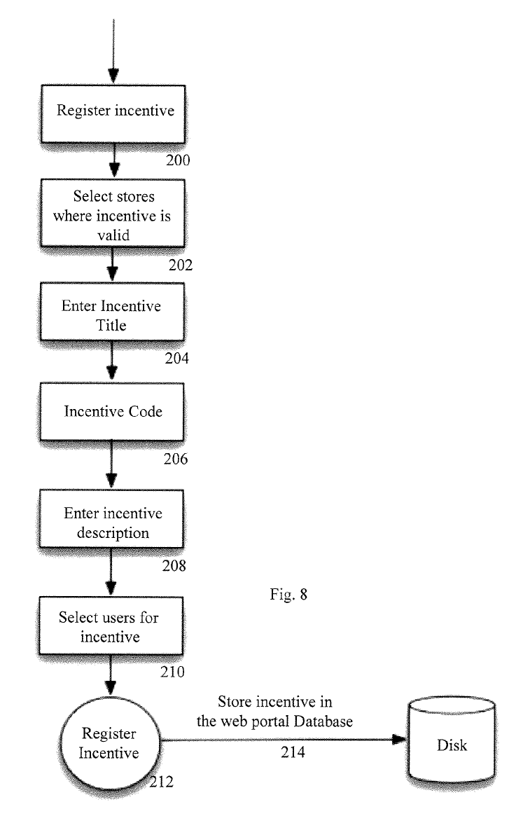

Referring to FIG. 6, a log-in procedure is presented for the merchants. As with the consumer log-in procedure, the merchants contact System 14 at the web portal 160 from the POS vendors data entry terminals 20a and merchants data entry terminals 20b. The first question the Software presents to the merchant, as seen with consumer log-in procedure, shown in decision box 162 is whether the merchant is registered. If the merchant answers “No” the Software of System 14 invites the merchant to create an account, as shown in block 166. If the answer is “Yes” then the merchant logs in as shown in block 164. The Software asks two sequential questions as shown in decision boxes 168 and 170. In decision box 168, the Software asks the merchant if she wants to register electronic coupons. If the merchant answers “No” then the Software proceeds to decision box 170. In decision box 170, the merchant is asked if she wants to register incentives. Answering “Yes” to the first question causes the Software to proceed to the steps shown in FIG. 7, while answering “Yes” to the second question causes the Software to proceed to the steps shown in FIG. 8. Answering “No” to both decision boxes stops the procedure in FIG. 6 (block 171).

In FIG. 7 the Software allows the merchant to register electronic coupons and associate the coupon with a coupon code. The Software allows merchant to begin registering electronic coupons in entry block 180. In block 182 the merchant is given an option to select the stores where the electronic coupons will be valid. In block 184 the merchant enters the title of the electronic coupon, followed by entering expiration date (block 186), electronic coupon code (188), electronic coupon description (190), and associated keywords 60 (192). In block 194 the Software allows the merchant to bid on the associated keywords 60 or based on system-stored keywords 44 as discussed in FIG. 2. More on the merchant bidding feature of the present teachings is provided below.

System 14, in accordance with the present teachings, receives revenues by a combination of ways. One way is by allowing merchants to bid on keywords associated with incentives. Another way may be by displaying advertisements. As the merchant enters keywords associated with electronic coupons, the merchant also bids on each associated keyword to be matched with the consumer's list. For example, and as shown in FIG. 2, a dairy manufacturer specifies the keywords milk, skim milk, cream, butter, margarine, coffee creamer, etc. Additionally, System 14 presents system-stored keywords such as “soy milk.” The merchant then places bids on some or all of the associated keywords. When a match occurs between these associated keywords and the consumer-specified items in her list, the consumer accepts the coupon so that the coupon is attached to the item in the list, and the consumer receives the electronic coupon by way of a mobile communication device 16 or her computing device, then the manufacturer is charged the bid amount for the associated keyword. It should be understood that the consumer's acceptance of the coupon is linked to System 14 receiving that acceptance.

FIG. 9 shows the typical situation associated with the bidding process. Here MooCow Milk is a dairy manufacturer. The manufacturer provided milk and skim milk as keywords 60. The Software of System 14 provided system-stored keyword 44 of “soy milk” organized under the category of Dairy. The manufacturer bid $0.10 for the keyword milk, 0.05 for soy milk, and $0.03 for skim milk. The strategy the manufacturer adopted was based on the likelihood of a match between the item the consumer entered in her list 40 and the terms milk, soy milk and skim milk.

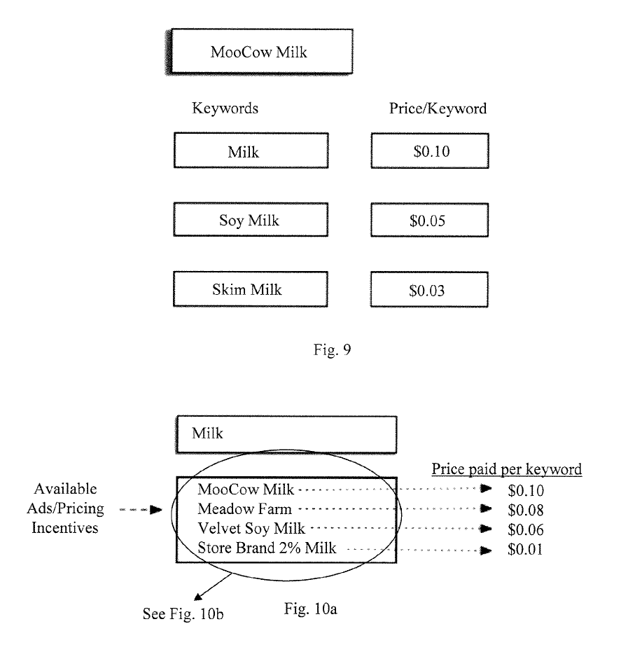

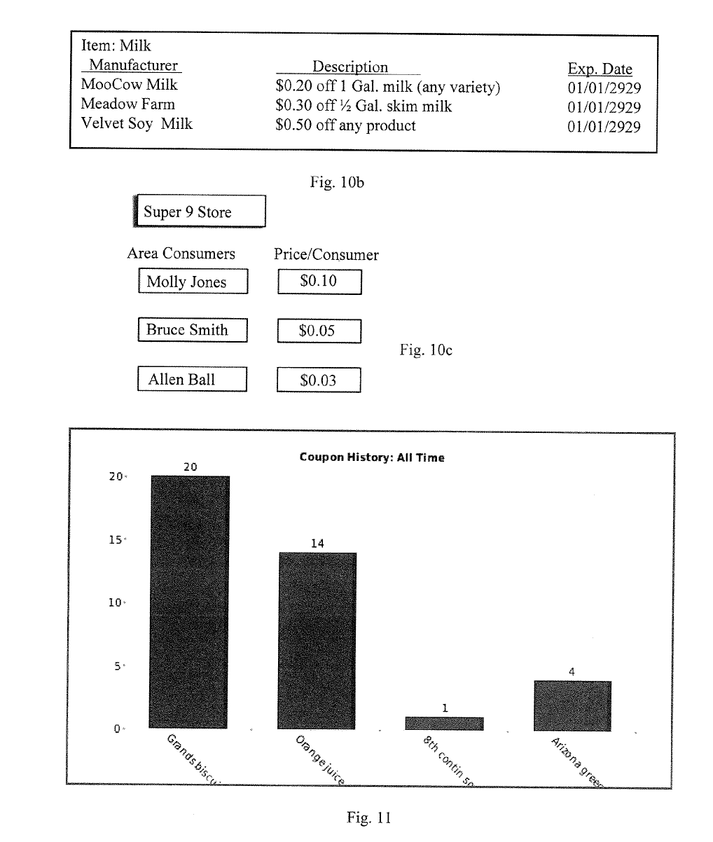

The bidding process is also designed so that when more than one manufacturer is registering electronic coupons, the highest bidder will be presented to the consumer first. In the event two manufacturers happen to bid the exact same amount, the manufacturer which registered first will be presented to the consumer first. Therefore, manufacturers involved in bidding are encouraged to bid higher to improve their chances of being presented to the consumer ahead of another manufacturer. The choice of which coupon the consumer will ultimately choose is dependent on many factors, e.g., the order in which the manufacturers are presented to the consumer, previous experience of the consumer with the product of the manufacturer, the amount of savings presented to the client for each coupon, and client's own knowledge as to the cost of the item before the coupon savings. Choices associated with electronic coupons are exemplified in FIG. 10a. As mentioned above, the manufacturer with the highest bid, i.e., MooCow Milk, for the word “milk” is presented at the top of the list. The information associated with phantom arrows in FIG. 10a are not shown to the consumer but presented in FIG. 10a to clarify the reason for the order of presentation. A more complete presentation of electronic coupon reports is provided in FIG. 10b. In FIG. 10b an example of what the Software presents to the consumer in block 146 of FIG. 5 is shown.

Momentarily referring to FIG. 5, after the consumer has entered the term “milk” in list 40, the Software searches in merchant provided keywords 60 and system-stored keywords 44 for the term “milk” which have bids associated with them. The Software may find one or several matches. Each keyword in merchant provided keywords 60 and system-stored keywords 44 that are associated with bids are examined by the Software and sorted based on the highest bids to lowest. The incentives associated with the keywords (60 and 44) are then presented to the consumer based on the sorted order.

Referring to FIG. 10b, MooCow Milk's incentive of “$0.20 off 1 Gal. milk (any variety)” expiring “01/01/2929” was sorted by the Software as having the highest bid amount of any other manufacturer for any other incentives. Referring to FIG. 10b, the amount “MooCow Milk” had bid on the word “milk” was $0.10. The second highest bid amount belonged to “Meadow Farm” for $0.08 for the word “milk.” Their incentive is for “$0.30 off ½ Gal. skim milk” expiring on “01/01/2929.”

The strategy of manufacturers bidding on keywords is also affected by the amount of discount they offer consumers. Therefore, the manufacturer has to strike a balance between amounts the manufacturer bids on keywords and the discount which the manufacturer offers the consumer by each coupon. Furthermore, if the consumer chooses MooCow Milk as her preferred coupon and receives the coupon on her mobile communication device or computing device, then MooCow Milk will be charged $0.10 for that consumer's pick.

Returning to FIG. 7, once the merchant has placed bids on the associated keywords 60, the Software registers electronic coupons (box 196). Additionally, the Software stores the electronic coupons in the database as shown by arrow 198.

Now referring to FIG. 8, a POS vendor is allowed to register incentives by entering the procedure outlined in FIG. 8. The Software allows a POS vendor to register incentives at the entry block 200. The POS vendor selects stores where the incentives are valid (block 202). Next the incentives title is entered (block 204), followed by incentive code (block 206) and incentive description (block 208). A similar bidding process as described with reference to FIG. 7 is also applied in FIG. 8. However, here, the POS vendor bids on potential consumers. Information on these consumers is presented to the POS vendor by System 14 based on a variety of factors. These factors include distance from the store location, coupon usage trends, etc. The POS vendor places bids on consumers based on the information that is provided by System 14. An example of a POS vendor bidding process is shown in FIG. 10c.

Area consumers are presented to the POS vendor and the POS vendor places bids on the consumer information. Similar to the bidding description provided with reference to FIG. 7, the highest POS vendor bidder is presented to the consumer first. For example, the Software presents “Molly Jones,” “Bruce Smith,” and “Allan Ball” to the POS vendor in a report, not shown. In that report, distance from each store of the POS vendor, trends in receiving incentives, types of incentives, and other useful information are specified. The POS vendor viewing this report bids on individual consumers. This consumer-targeted bidding allows the POS vendor to improve chances of the consumer shopping at their location. Therefore, according to FIG. 10c, Super Store 9, a POS vendor with multiple store locations, bid $0.10 on “Molly Jones,” etc. If amongst all of the POS vendors, “Super Store 9” had the highest bid for “Molly Jones” then “Super Store 9” would be presented to “Molly Jones”. This presentation occurs, as explained above, in block 146 of FIG. 5, after “Molly Jones” began entering items on a list. After the consumer selects a POS vendor incentive, the consumer accepts the incentive so that the incentive is attached to the consumer information, and the consumer receives the incentive code by way of a mobile communication device 16 or electronically at her computing device, then the POS vendor is charged the bid amount for the incentive. It should be understood that the consumer's acceptance of the incentive is linked to System 14 receiving that acceptance.

Referring back to FIG. 8, once the POS vendor has completed the process of bidding on the consumers, the incentives is registered as shown in block 212, of FIG. 8, and the store incentive is logged in by the Software of System 14 in the database as shown by the arrow 214.

Referring now to FIG. 11, a sample of the report that a merchant, or similarly a POS vendor, can receive from System 14 is shown. The report can be tailored to show weekly, monthly, yearly, year-to-date, and all-time dispensation of the incentives. The report can also be tailored to show buying trends of other items sold by other manufacturers or POS vendors so that the merchant or POS vendor can better target their bidding process.

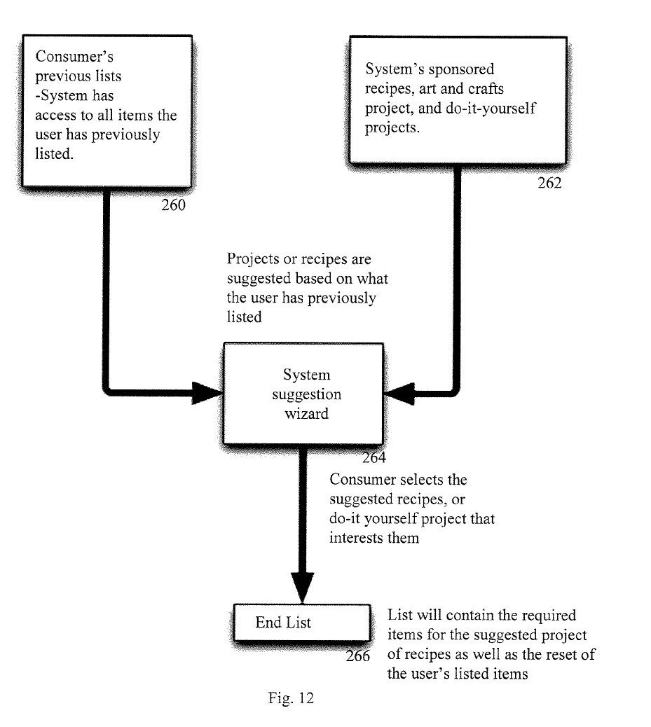

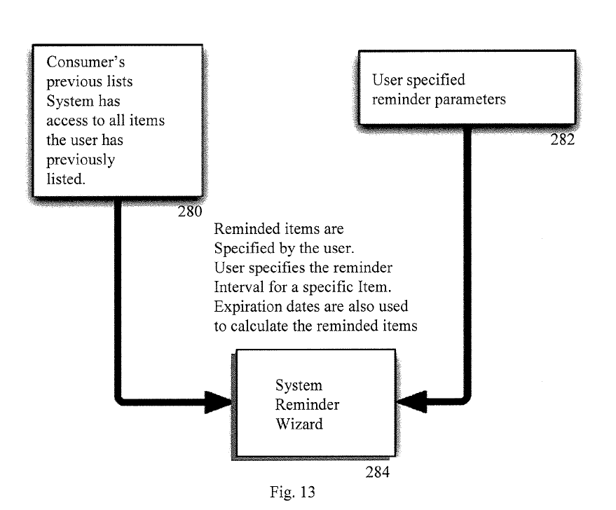

Referring to FIGS. 12 and 13, two additional features of System 14 are shown and are discussed as follows. In FIG. 12, a system suggestion wizard is shown. The suggestion wizard feature (block 264) is designed to provide suggestive feedback to the consumer based on the list items which have been previously logged into System 14 (block 260) and system-stored recipes, arts and crafts projects, and do-it-yourself projects (block 262). For example, and as was shown in FIG. 2, the consumer indicated milk, flour, walnuts, chicken, and eggs on her list. The Software matches these keywords to keywords from system-stored recipes. Then the suggestion wizard feature of System 14 suggests to the user possible recipes. For example, based on the above list, the suggestion wizard may suggest several different types of cake, or several types of chicken dishes. Once the consumer has reviewed the suggested recipes and selected one or more of these recipes, the Software provides to the consumer complete directions as to how to make the dish, complete the arts and crafts or do-it-yourself project (block 266).

In FIG. 13, a system reminder wizard feature is shown. The system reminder feature of the Software accesses the task list generated by the user (block 280) and based on the user specified reminder parameters (block 282) causes a reminder to appear either by email or by communicating with the user's mobile communication device (block 284). Also, as part of the reminder wizard feature, the consumer can enter expiration dates of the items she purchases. This can be done by listing an item and specifying a reminder parameter so that the Software of System 14 reminds the consumer the item is about to expire. Also, the reminder wizard is capable of issuing reminders based on the expiration dates of the incentives that were logged in. This feature is accomplished based on the availability of the incentive expiration data.

Another feature of the Software of System 14 is an incentive optimization option. The Software is capable of accessing the consumer-generated lists, address of the consumer, electronic coupons issued by merchants which were matched with the items on the consumer's list 40, store locations where those coupons are valid, location of POS vendors, and POS vendor incentives to suggest where the consumer can maximize her savings. Therefore, the Software based on the above information, may suggest traveling to local store number 1 located n miles from the consumer will result in $X of savings, while traveling to local store number 2 located m miles from the consumer will result in $Y of savings. The Software calculates the savings based on the selected incentives by the consumer from the list of manufacturers' incentives and based on the selected incentives from the POS vendors. The optimized savings is a snapshot of the information available to the Software and could be relative. That is, the Software may suggest $X savings. However, the Software may have no information on the cost of items at the POS vendor's location. That is, while the consumer is relying on a substantial savings based on the incentive optimization feature, she may be disappointed when she finds out the actual cost of the items is higher at the suggested POS vendor making the incentive optimization feature without value. Therefore, the incentive optimization feature is further contemplated to receive pricing of items listed in the consumer's list from the POS vendors to provide a complete and accurate savings report to the consumer based on current and actual pricing information. The consumer can choose which location is preferable, and consequently receive a map from their home location to the store location.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of distributing incentives to consumers, comprising:
receiving a first list from a consumer, the first list having at least one item the consumer wishes to purchase;
receiving an incentive from at least one incentive provider, the incentive being associated with a keyword on a second list of keywords;
comparing the keyword in the second list to the at least one item in the first list;
creating a third list which includes the incentive associated with the keyword if the keyword matches the at least one item in the first list;
transmitting the third list to the consumer to permit the consumer to choose the incentive;
receiving the consumer's choice of the incentive; and
transmitting to the consumer the incentive.

2. The method in accordance with claim 1 further comprising:
receiving a bid from the at least one incentive provider on the keyword; and
charging the at least one incentive provider the bid amount after the incentive is transmitted to the consumer.

3. The method in accordance with claim 2 wherein the third list has an order of highest bidder to lowest bidder.

4. The method in accordance with claim 2, further comprising:
storing a plurality of system-suggested keywords under at least one class;
identifying a category associated with the incentive;
comparing the category with the at least one class;
providing to the at least one incentive provider a fourth list of system-suggested keywords of the plurality stored under the at least one class that matches the category; and
combining the system-suggested keywords of the fourth list with the keyword of the second list.

5. The method in accordance with claim 1 wherein the first list is received over the internet.

6. The method in accordance with claim 1 wherein the second list is received over the internet.

7. The method in accordance with claim 1 wherein the incentive is associated with an incentive code.

8. The method in accordance with claim 1 wherein transmission of the incentive is accomplished by communicating with one of the consumer's cellular telephone, a kiosk, and a moveable wireless device.

9. The method in accordance with claim 1 wherein transmission of the incentive is accomplished by communicating with the consumer's computing device.

10. The method in accordance with claim 1, further comprising providing a plurality of reports to the at least one incentive provider.

11. The method in accordance with claim 10 wherein the plurality of reports include incentive usage by a plurality of consumers on a weekly, monthly, yearly, year-to-date, and all-time bases.

12. The method in accordance with claim 1, further comprising:
storing a project direction, the project direction having instructions on how to accomplish a project;
identifying a project keyword in the project direction;
comparing the at least one item of the first list to the project keyword;
creating a fifth list which includes the project direction associated with the project keyword if the project keyword matches the at least one item in the first list;
transmitting the fifth list to the consumer to permit the consumer to choose the project direction;
receiving the consumer's choice of the project direction; and
transmitting to the consumer the project direction.

13. The method in accordance with claim 1 further comprising:
receiving a fixed charge amount from the at least one incentive provider; and
charging the at least one incentive provider the fixed charge amount after the incentive is transmitted to the consumer.

14. The method in accordance with claim 13 wherein the third list has an order of highest fixed charge amount to the lowest fixed charge amount.

15. A method of distributing incentives to consumers, comprising:
receiving an incentive from at least one incentive provider;
transmitting to the at least one incentive provider a first list having information associated with consumers;
receiving bids from the at least one incentive provider on the information associated with consumers in the first list, each bid associated with the incentive;
communicating with a user;
comparing information of the user with the information associated with consumers in the first list;
creating a second list which includes the incentive associated with the at least one incentive provider that placed bids on the information associated with consumer in the first list if the information of the user matches the information associated with consumers;
transmitting to the user the second list to permit the user to choose the incentive;
receiving the user's choice of the incentive;
transmitting to the user the incentive; and
charging the at least one incentive provide the bid amount associated with the incentive.

16. The method in accordance with claim 13 wherein the first list is transmitted to the at least one incentive provider over the internet.

17. The method in accordance with claim 13 wherein the second list is transmitted to the user over the internet.

18. The method in accordance with claim 13 wherein the incentive is associated with an incentive code.

19. The method in accordance with claim 13 wherein the second list is in an order of highest bidder to lowest bidder.

20. The method in accordance with claim 13 wherein transmission of the incentives is accomplished by communicating with one of the consumer's cellular telephone, a kiosk, and a moveable wireless device.

21. The method in accordance with claim 13 wherein transmission of the incentives is accomplished by communicating with the user's computing device.

22. The method in accordance with claim 13, further comprising providing a plurality of reports to the incentive providers.

23. The method in accordance with claim 20 wherein the plurality of reports include incentive usage by a plurality of consumers on a weekly, monthly, yearly, year-to-date, and all-time bases.
